(19) United States
(12) Patent Application Publication
(10) Pub. No.: US 2010/0296933 A1
(43) Pub. Date: Nov. 25, 2010

(54) TRANSMISSION SYSTEM FOR POWER GENERATION

(75) Inventors: Raymond John Hicks, Powys (GB); Frank Cunliffe, Gloucostarshire (GB)

Correspondence Address: KING & SCHICKLI, PLLC, 247 NORTH BROADWAY, LEXINGTON, KY, 40507, US

(73) Assignee: Orbital 2 Limited

(21) Appl. No.: 12/680,996

(22) PCT Filed: Oct. 1, 2008
(86) PCT No.: PCT/GB2008/003358

§ 371 Date: Jul. 12, 2010

(30) Foreign Application Priority Data
Oct. 1, 2007 (GB) 0719119.0

(51) Int. Cl. F03D 11/02; F16H 1/46; F16H 1/02; F03B 13/00

(52) U.S. Cl. 416/170 R; 475/31; 74/730.1

(57) ABSTRACT

A transmission (10) is disclosed for use in generating power from a fluid driven turbine such as a wind turbine (5). The transmission (10) is supported in a turbine carrier (50) and includes an input (12) and an output (20) and a gear train (14/16) between the input and the output for increasing the rotational speed of the output relative to the input. The gear train includes a plurality of gears for transmitting torque from the input to the output. The transmission includes also a generally static planet carrier (44) of an epicyclic gear stage (16), which is resiliently connected to the turbine carrier for providing a single resilient gear train torque reaction. Thus, the transmission is not restrained relative to the carrier other than in torsion and in the support of its own weight.

The present invention relates to a transmission system, particularly, but not exclusively, for driving a generator or the like by means of a fluid driven rotary prime mover such as a wind or tidal power turbine.

It is generally accepted that large turbines, for example wind turbines producing electricity for feeding to a grid system, require a large and heavy supporting structure because they are subjected to large forces, which act in many directions. A conventional answer to accommodating these large forces is to make a turbine carrier casing which is very strong and rigid. Since large turbines rotate relatively slowly, they have very high torque and it is usual to increase their slow speed by using step-up gearing as part of the turbine carrier, to produce a more useful rotary speed.

In order to avoid misalignment of the gears used, the turbine carrier, in which the gearing is supported has to made even more rigid so that it does not distort, not only under the influence of the varied turbine forces but also under the influence of internal torques within the gearing. Speed reducing geared transmissions for transmitting large torques to slow moving heavy machinery are known commercially, but such transmissions do not address the problems mentioned above. The inventors have realised that an improved design of turbine transmission will address at least the problems mentioned above.

The present invention provides a transmission for use in generating power from a fluid driven turbine, the transmission including an input and an output and a gear train between the input and the output for increasing the rotational speed of the output relative to the input, the gear train including a plurality of gears for transmitting torque from the input to the output, the transmission including also a generally static member engaged with one or more gears of said train between the input and the output for providing a single resilient gear train torque reaction.

Preferably the transmission further includes a resilient support for the static member for providing limited resilient rotation of said member about a static member axis

More preferably the input is rotatable about an input axis, the static member axis and input axis being substantially co-axial.

Yet more preferably the resilient support includes an elongate torsion member for resilient twisting about a torsion axis.

In one embodiment the torsion member has two ends and a first arm secured to, and adjacent, one end of the torsion member, the first arm extending generally radially away from the torsion axis.

It is preferred that the transmission further includes a first tie, coupling the static member at a first region spaced from the member axis, to the first arm, for transmitting the torque reaction between the static member and the torsion member for causing said twisting of said torsion member.

In an embodiment a second arm is provided adjacent the other end of the torsion member, and a second tie is provided coupling the static member, at a second region spaced from the member axis and opposite the first region, to the second arm for transmitting also torque to the torsion member in an opposite sense to the torque transmitted by the first tie.

Preferably the torsion axis is substantially perpendicular to, but spaced from, the static member axis

In an embodiment the transmission includes a cover which is attached to the member and supports at least a portion of the weight of the transmission but is subjected to little or no torque from the input.

Optionally the gear train includes at least a first epicyclic gear train forming a first torque path and having a first annulus, first planet gears and a first sun gear and the generally static member includes a carrier of the first planet gears.

Preferably the first annulus is connected directly to the input, for driving the first planet gears and the first planet gears are arranged to drive the first sun gear.

More preferably the gear train includes a second epicyclic gear train forming a second torque path, the first and second paths sharing torque from the input, only the first train having the generally static member.

If a second epicyclic gear train is employed it may have a second annulus, second planetary gears and a second sun gear, the first sun gear in use driving the second annulus, and the second planetary gears being driven in use by the input.

Preferably the first epicyclic gear train is arranged to transmit approximately two thirds of the power delivered to the input and the second epicyclic train is arranged to combine the two thirds of the power from the first train with the remaining third of the input power.

The invention extends to support for a fluid driven turbine, the support including a turbine carrier providing rotational support for a turbine, and gearing for transmitting torque from the turbine to a generator, and a resiliently movable member mounted to the turbine carrier and engaged with the gearing for resiliently reacting the torque in the gearing.

The invention further extends to a fluid driven turbine support and transmission assembly including a turbine carrier, and a transmission for use in generating power from the fluid driven turbine, the transmission including an input and an output and a gear train arrangement between the input and the output for increasing the rotational speed of the output relative to the input, the gear train arrangement including a generally static member being connected to the turbine carrier by a mechanism and being substantially restrained in one degree of freedom only relative to the turbine carrier by said mechanism.

Preferably, said restraint is resilient and said one degree of freedom is rotation.

More preferably, said rotation is rotation about an axis coaxial with an axis of the input.

Conveniently, the static member is a planet carrier of an epicyclic gear train.

The invention extends to any novel features disclosed herein or any novel combination of features disclosed herein, whether or not those features are described in that combination.

The invention can be put in to practice in numerous ways. Two illustrative embodiments of the invention are described below by way of example, with reference to the drawings, wherein:

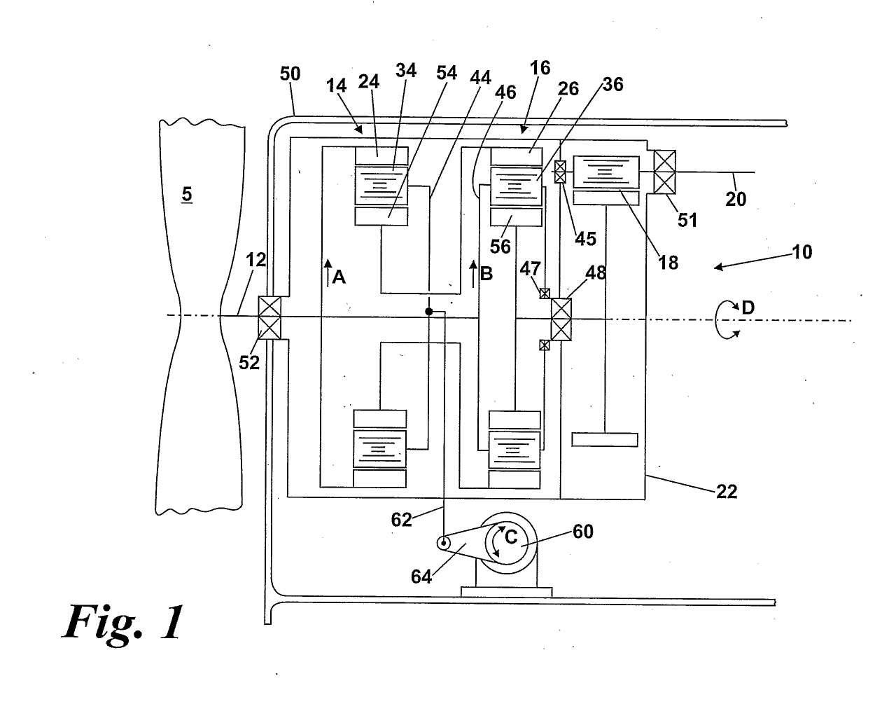

FIG. 1 shows a simplified schematic representation of a transmission mounted to a wind turbine carrier;

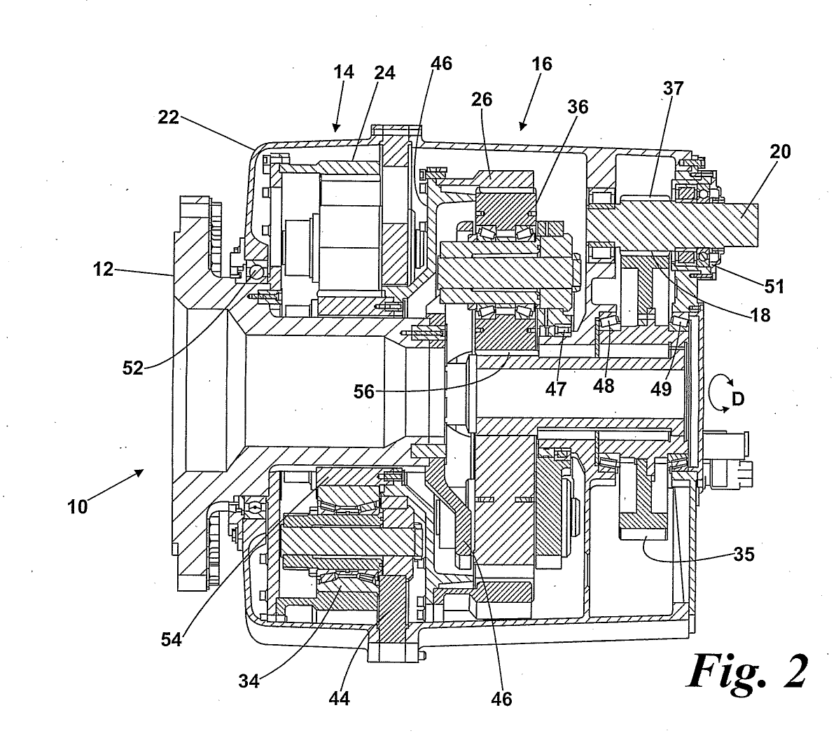

FIG. 2 shows a section through a transmission designed in accordance with the schematic representation shown in FIG. 1;

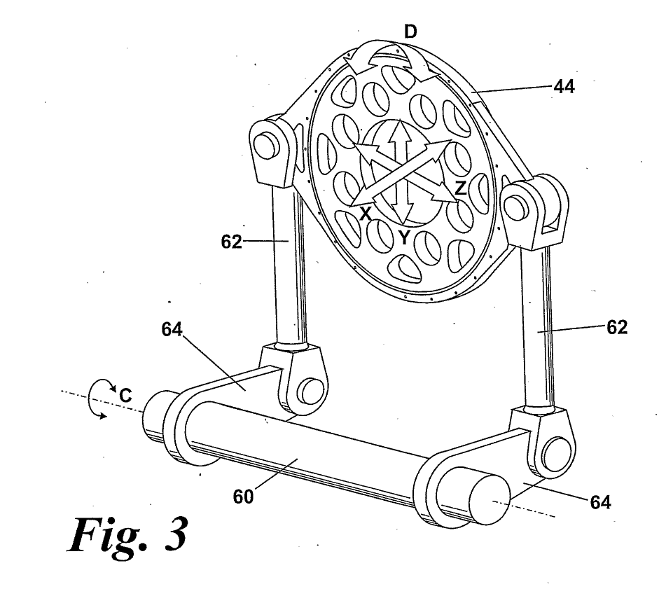

FIG. 3 shows a pictorial view of a part of the transmission shown in FIG. 2 together with a support;

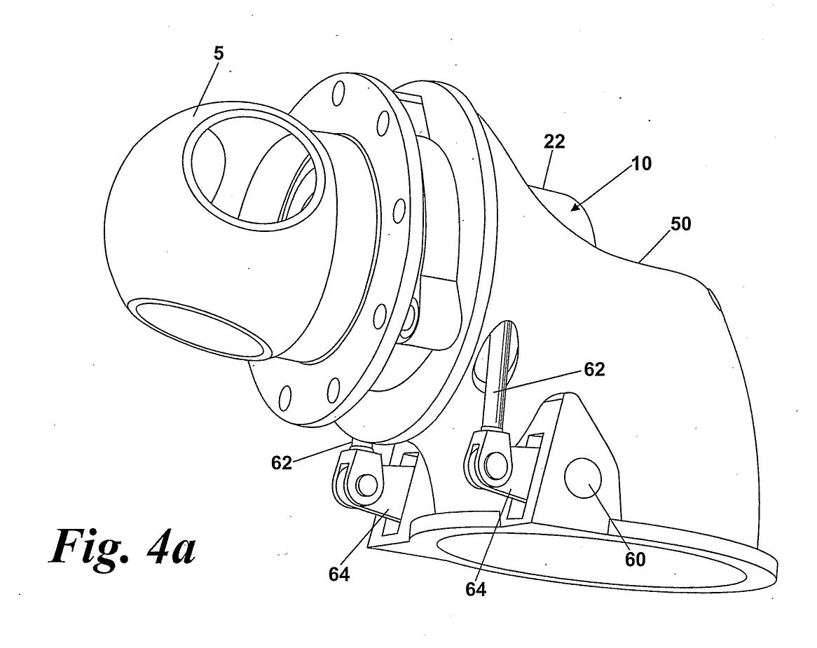

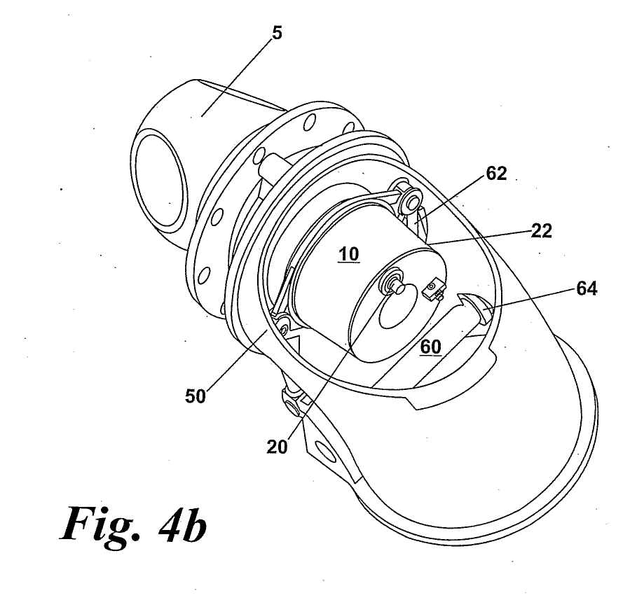

FIGS. 4a and 4b show two different pictorial views of parts shown in FIGS. 2 and 3, as part of a turbine carrier assembly;

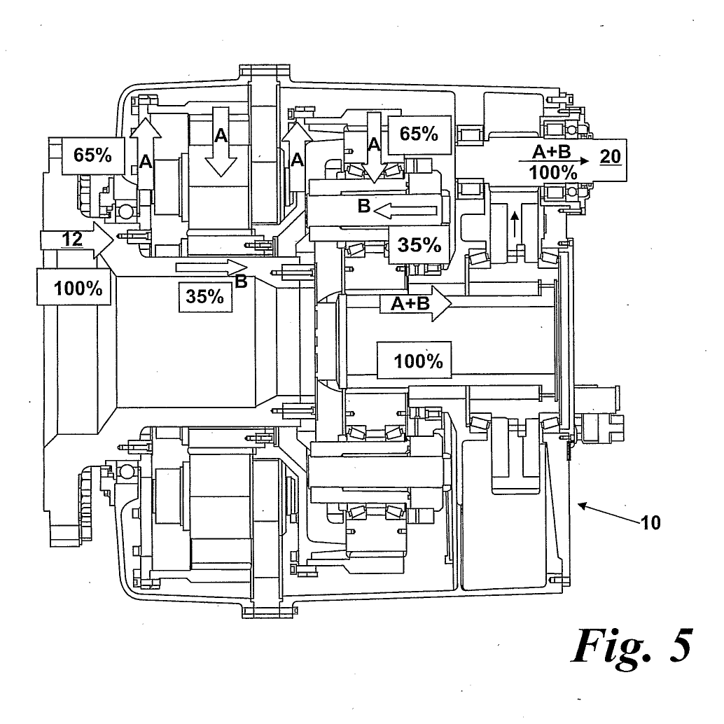

FIG. 5 shows the power paths of the transmission shown in FIG. 2.

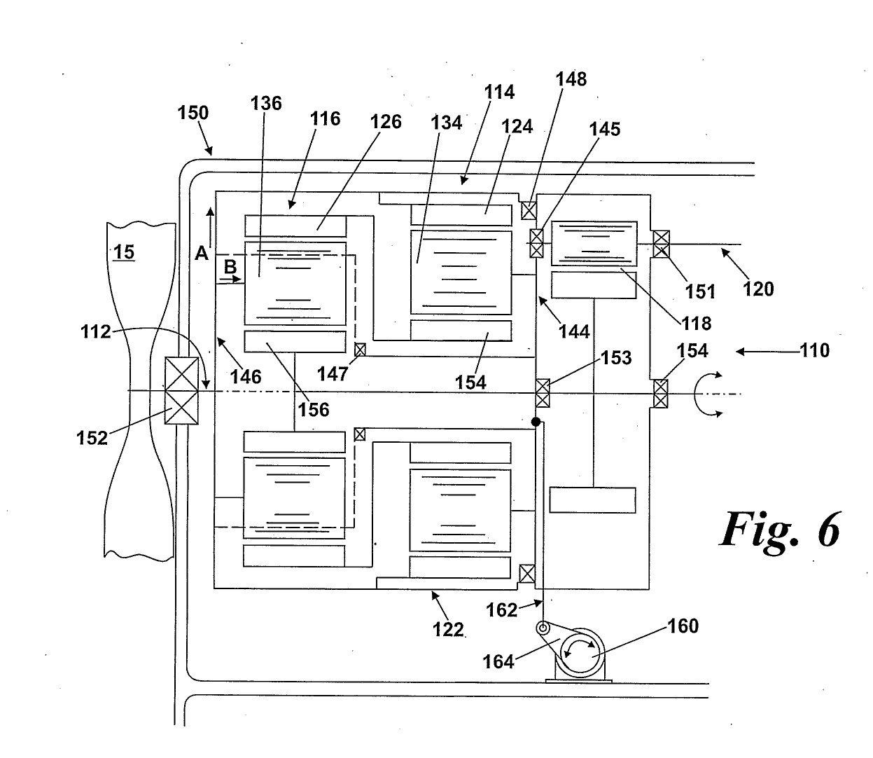

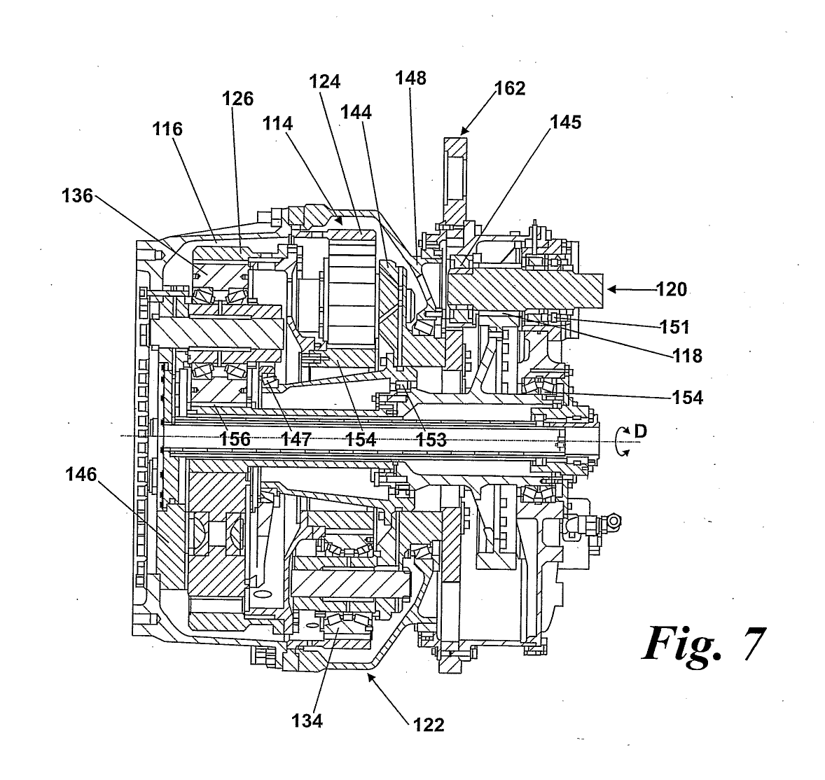

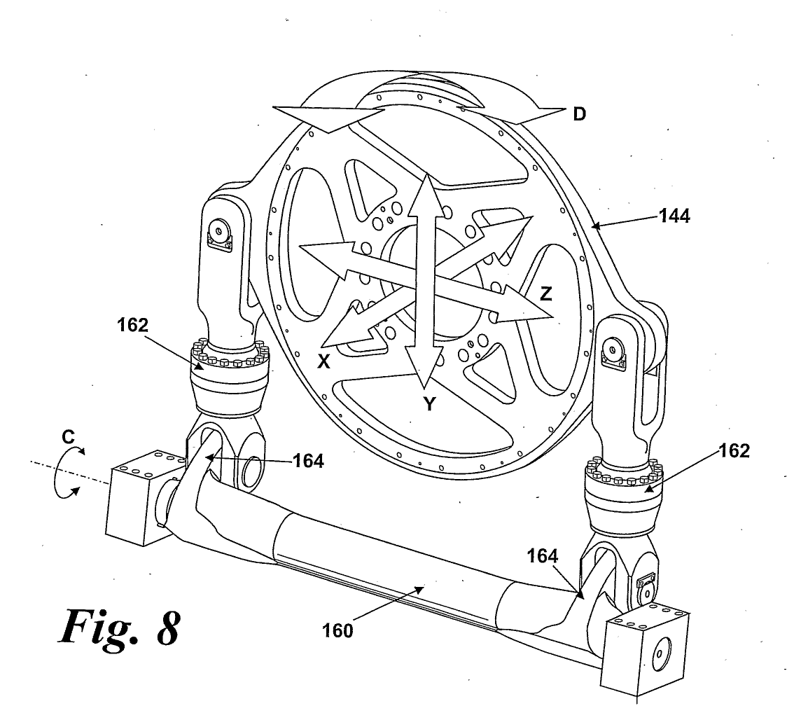

FIGS. 6 to 10 show a second version of a wind turbine transmission which is similar to the transmission shown in FIGS. 1 to 5 respectively.

FIG. 1 shows a transmission 10 which provides a step-up rotary drive for a wind turbine 5 to an output 20. Typically a 1:15 step-up ratio will be required but higher or lower ratios are possible. The transmission 10 has an input shaft 12 which feeds two epicyclic gear trains 14 and 16, which split power from the input along two paths A and B. The turbine 5 and the transmission 10 are supported by a turbine carrier 50.

In path A power is supplied to an annulus 24 of the train 14. The annulus 24 drives a star train 34 i.e. a set of planet gears whose centres of rotation are fixed by a generally static member in the form of planet carrier 44. The rotatable planet gears 34 in turn drive a sun gear 54.

In path B power from the input is supplied to planet carrier 46. The power from train 14 is also supplied to the annulus 26 of the train 16. Thus, both power paths A and B are combined to drive sun gear 56. In turn, sun gear 56 drives output 20 via an additional pinion gear pair 18.

The transmission has bearings 45,47, 48, 51 and 52 which support the weight of the transmission 10 and keep the relative alignment of the gears in the transmission 10. The transmission 10 has a cover 22 which is not subjected to torque loadings. The transmission 10 is arranged such that a torque reaction to stop the whole transmission spinning is required only at planet carrier 44. This reaction is resilient so the whole transmission can twist relative to the turbine carrier 50 and any sudden torque increases can be smoothed by the twisting of the carrier 44.

The support for the planet carrier 44 is provided by a torsion member which in this instance is a tube 60, mounted to the turbine carrier 50 and is capable of twisting about its axis C and thereby allowing the planet carrier 44 to twist about its axis of rotation D, when the planet carrier 44 forces a tie rod 62 and torsion arm 64 to twist the torsion member 60.

FIG. 2 shows a more detailed view of the transmission 10 shown in FIG. 1. Like numbering in FIGS. 1 and 2 show like parts. It will be noted that the planet carrier 44 is mounted directly to the cover 22, but that the cover is not subjected significant torque, even though it carries the weight of the transmission 10.

FIG. 3 shows planet carrier 44 shown in FIG. 2, without the other transmission parts, together with the torsion tube 60 the torsion arms 64 and tie rods 62. In use, the planet carrier is able to rotate to a limited degree about axis D. Additionally some compliant movement is possible in the X Y and Z linear directions. The torsion tube 60 is forced to twist about its axis C by the torque forces exerted on the planet carrier 44, transmitted to the torsion tube by means of the tie rods 62 and torsion arms 64.

FIG. 4a shows the turbine carrier 50 assembled together with the torsion tube 60 and the transmission 10 connected to the torsion tube 60 by the tie rods 62 and torsion arms 64. Torsion tube 60 is mounted to the turbine carrier 50 so that it can rotate about its axis C. In use, torque on the carrier 44 induces upward forces in one tie rod and downward forces in the other. These tie rod forces cause torsion in the tube 60. In practice, this torsion reacts against torsion exerted on the planet carrier 44 in the transmission 10 so that only limited resilient rotation of the planet carrier is possible.

FIG. 5 shows a further view of the transmission 10 illustrating the percentage of power travelling through paths A and B In this instance, as a result of the arrangement of the gears, and the number of teeth for the gears, approximately two-thirds (65%) of power travels through path A and approximately one-third (35%) travels through path B. Paths A and B are combined at the output.

FIGS. 6 to 10 correspond respectively with FIGS. 1 to 5 and like parts have like reference numerals, with the additional prefix ‘1’, for example the turbine input shaft is referred to as shaft 12 in FIGS. 1 to 5 and as shaft 112 in FIGS. 6 to 10.

Reference can be made to the corresponding FIGS. 1 to 5 to provide a description of the operation of the transmission shown in FIGS. 6 to 10., although differences in the transmissions 10 and 110 are described below.

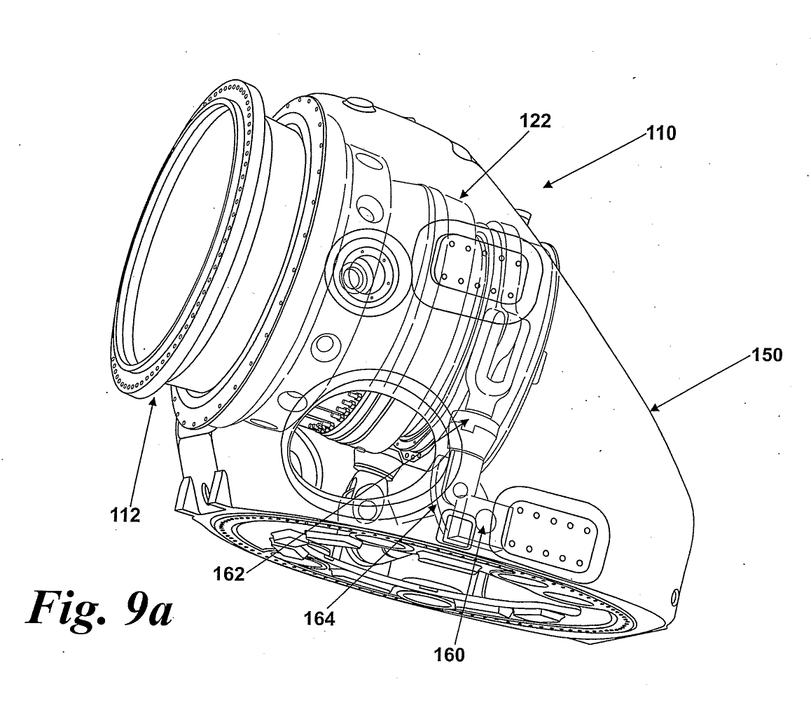

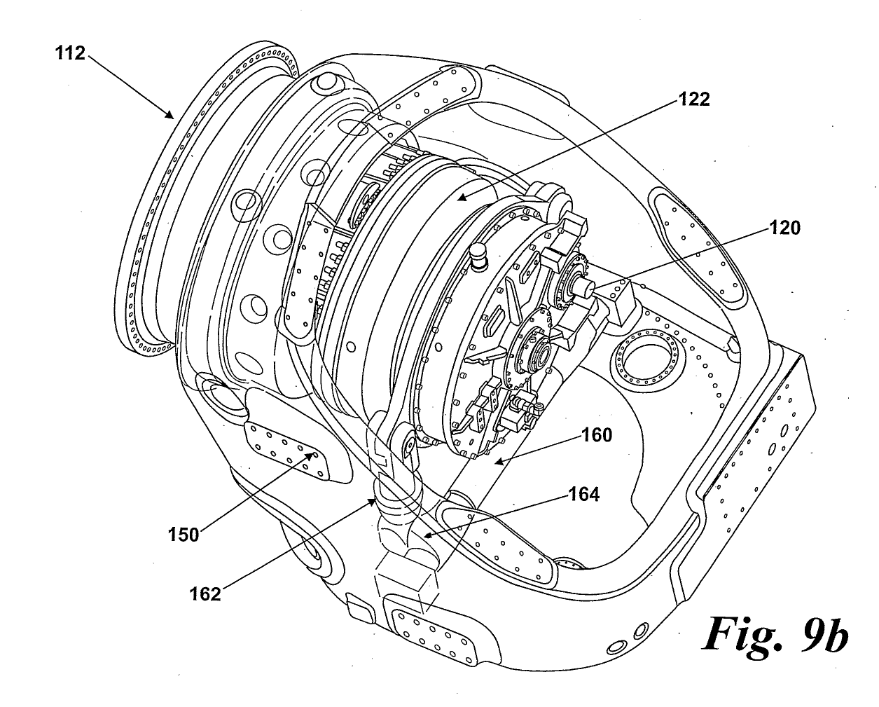

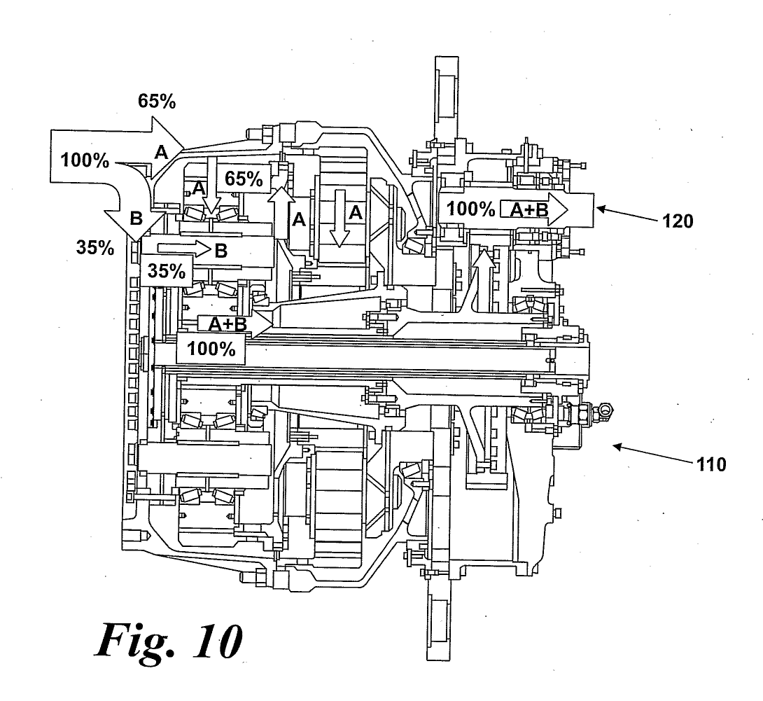

In transmission 10 described above, the epicyclic gear train 16 which contains star train 34 and planet carrier 44, is further away from the input 12 than the gear train 14. Conversely, the transmission 110 the gear trains 114 and 116 which correspond with gears trains 14 and 16, are reversed so that gear train 116 is now closer to the input 112 than the gear train 114. The principles of operation of transmission 110 are otherwise the same as transmission 10, except that planet carrier is further from the input. It will be noted that the cover 122 rotates because it forms part of the gear train. The cover 122 merely transmits torque and carries the weight but is not subjected to external forces. The same split in power is provided between power paths A and B, and this is quantified and illustrated in FIG. 10. In FIGS. 9a and 9b the turbine support 150 is shown so that the parts within the support are viewable in the drawings, although in practice the support 150 will be a metal casting which is opaque.

The transmissions illustrated and described above have the advantage that the gearbox casing 22/122 and hence the gears of the gearbox are be generally mechanically isolated from the surrounding structure, in this case the wind turbine carrier 50/150, and so any flexing of the turbine carrier is not translated into gear misalignment or gear stress. This prolongs the life of the gears and increases efficiency.

The transmissions 10/110 are arranged such that, other than being supported such that the transmission gears stay in contact with each and such that their weight is supported, only one static element 44/144 of the gear train is restrained in one degree of freedom, relative to the turbine carrier 50/150. That degree of freedom is rotation, in this case rotation about the input axis. The restraint in this case is resilient such that resilient rotational freedom is applied, allowing limited rotation which is urged back to an initial starting position. The static element 44/144 is not restrained against movement in any other sense relative to the turbine carrier 50/150 by the resilient rotational restraint, i.e. no restraint in the three linear degrees of freedom is imparted by parts 62/162,64/164 or 60/160, and there is no restraint in the other two rotational degrees of freedom. Consequently the transmission 10/110 has no external stresses imparted to it during operation other than those reacting against the static element's 44/144 urge to rotate. This in turn provides a transmission that does not need to have a significantly rigid casing and has lower operating stresses. The output 20/120 may be connected to a generator or the like by a flexible coupling so that no stress is imparted into the transmission 10/110 if the transmission moves slightly in rotation.

Whilst only two embodiments of the invention have been described and illustrated, it will be apparent that various modifications, alternatives, adaptations etc are possible within the ambit of the invention described herein. One example of a torsion tube 60/160 and tie rods 62/162 have been described and illustrated, but other torsion resisting members could be used, for example one tie rod could be used to twist a torsion tube, the tube having one end secured to the turbine carrier, or a simple cantilever could be used to resist rotation or an elastomeric torque reaction member could connected between the static member of the transmission 10/110 and the turbine carrier 50/150.

1. A transmission for use in generating power from a fluid driven turbine, the transmission including an input and an output and a gear train between the input and the output for increasing the rotational speed of the output relative to the input, the gear train including a plurality of gears for transmitting torque from the input to the output, the transmission including also a generally static member engaged with one or more gears of said train between the input and the output for providing a single resilient gear train torque reaction.

2. A transmission according to claim 1 wherein the transmission further includes a resilient support for the static member for providing limited resilient rotation of said member about a static member axis.

3. A transmission according to claim 2 wherein the input is rotatable about an input axis, the static member axis and input axis being substantially co-axial.

4. A transmission according to claim 2 wherein the resilient support includes an elongate torsion member for resilient twisting about a torsion axis.

5. A transmission according to claim 4 wherein the torsion member has two ends and a first arm secured to, and adjacent, one end of the torsion member, the first arm extending generally radially away from the torsion axis.

6. A transmission according to claim 5 wherein the transmission further includes a first tie, coupling the static member at a first region spaced from the member axis, to the first arm, for transmitting the torque reaction between the static member and the torsion member for causing said twisting of said torsion member.

7. A transmission according to claim 6 wherein a second arm is provided adjacent the other end of the torsion member, and a second tie is provided coupling the static member, at a second region spaced from the member axis and opposite the first region, to the second arm for transmitting also torque to the torsion member in an opposite sense to the torque transmitted by the first tie.

8. A transmission according to claim 5 wherein the torsion axis is substantially perpendicular to, but spaced from, the static member axis

9. A transmission according to claim 1 wherein the transmission includes a cover which is attached to the member and supports at least a portion of the weight of the transmission but is subjected to little or no torque from the input.

10. A transmission according to claim 1 wherein the gear train includes at least a first epicyclic gear train forming a first torque path and having a first annulus, first planet gears and a first sun gear and the generally static member includes a carrier of the first planet gears.

11. A transmission according to claim 10 wherein the first annulus is connected directly to the input, for driving the first planet gears and the first planet gears are arranged to drive the first sun gear.

12. A transmission according to claim 10 wherein the gear train includes a second epicyclic gear train forming a second torque path, the first and second paths sharing torque from the input, only the first train having the generally static member.

13. A transmission according to claim 12 wherein the second epicyclic gear train has a second annulus, second planetary gears and a second sun gear, the first sun gear in use driving the second annulus, and the second planetary gears being driven in use by the input.

14. A transmission according to claim 12 wherein the first epicyclic gear train is arranged to transmit approximately two thirds of the power delivered to the input and the second epicyclic train is arranged to combine the two thirds of the power from the first train with the remaining third of the input power.

15. A support for a fluid driven turbine, the support including a turbine carrier providing rotational support for a turbine, and gearing for transmitting torque from the turbine to a generator, and a resiliently movable member mounted to the turbine carrier and engaged with the gearing for resiliently reacting the torque in the gearing.

16. A support as claimed in claim 15 wherein the turbine carrier supports the weight of the gearing and provides said reaction to said torque, but has no other force influence on the gearing.

17. (canceled)

18. A fluid driven turbine support and transmission assembly including a turbine carrier, and a transmission for use in generating power from the fluid driven turbine, the transmission including an input and an output and a gear train arrangement between the input and the output for increasing the rotational speed of the output relative to the input, the gear train arrangement including a generally static member being connected to the turbine carrier by a mechanism and being substantially restrained in one degree of freedom only relative to the turbine carrier by said mechanism.

19. An assembly as claimed in claim 18 wherein, said restraint is resilient and said one degree of freedom is rotation.

20. An assembly as claimed in claim 19 wherein, said rotation is rotation about an axis coaxial with an axis of the input.

21. An assembly as claimed in claim 18 wherein, the static member is a planet carrier of an epicyclic gear train.
